(19) United States
(12) Patent Application Publication
(10) Pub. No.: US 2024/0367892 A1
(43) Pub. Date: Nov. 7, 2024

(54) BEVERAGE CONTAINER WITH A MOISTURE AND OXYGEN BARRIER FUNCTION

(71) Applicant: SOCIETE DES PRODUITS NESTLE S.A., Vevey (CH)

(72) Inventors: CHRISTOPHE SEBASTIEN PAUL HEYDEL, Chez-Le-Bart (CH); CHIARA PAVAN, Vullierens (CH)

(21) Appl. No.: 18/691,104

(22) PCT Filed: Sep. 1, 2022
(86) PCT No.: PCT/EP2022/074282

§ 371 Date: Mar. 12, 2024

(30) Foreign Application Priority Data
Sep. 14, 2021 (EP) 21196470.5

(51) Int. Cl. B65D 85/804; D21H 19/20

(52) U.S. Cl. CPC B65D 85/8043; D21H 19/20

(57) ABSTRACT

The invention relates to a beverage container (too) for preparing a beverage by injecting a fluid into a cavity (102) inside the beverage container (too). The cavity (102) is defined by a cellulose body (200) and encloses a substance for beverage preparation. The beverage container (too) has a layered structure (101) with a moisture and oxygen barrier function. The layered structure (101) comprises the cellulose body (200) and coating layers (300) that are applied on the cellulose body (200) as a layered construction. The coating layers (300) comprise a moisture barrier coating (320), which provides the layered structure (101) with the moisture barrier function. The coating layers (300) further comprise a surface coating (310) as a base coating, which forms the layer of the layered construction that is closest to the cellulose body (200). The invention also relates to a method for producing the beverage container (too).

### 1. FIELD OF THE INVENTION

The present invention relates to a beverage container for preparing a beverage by injecting a fluid into a cavity inside the beverage container, the cavity containing a substance for the beverage preparation. The present invention also relates to a method for producing said beverage container.

### 2. TECHNICAL BACKGROUND

Single-serve beverage containers, such as capsules or pods, are known in the art. These beverage containers are commonly used with beverage preparation machines for on demand dispensing of beverages, like coffee, tea or hot chocolate, and enjoy popularity due to fresh tasting, variability of flavours and convenience of the beverage preparation.

Usually, the beverage container contains a beverage component and is inserted in a container receiver of a beverage preparation machine. The container receiver is closed and the beverage preparation is started. A fluid, such as hot water or milk, is delivered to the beverage container to interact with the beverage component inside the beverage container to produce the desired beverage. When a sufficient amount of the fluid fills the beverage container, the beverage container opens under the pressure of the fluid to release the prepared beverage. Such beverage preparation is convenient as users can simply decide for a beverage of their liking, place a beverage container with the desired beverage components in a machine, start the beverage preparation process and consume the beverage immediately afterwards.

In the prior art, such beverage containers are usually made of plastic and/or aluminium. Considering that such beverage containers are configured for single time use only, the disposal of the beverage containers has to be managed since reusing and recycling such materials is challenging. Therefore, attempts are made to replace these materials with alternative materials that overcome existing problems with disposing and/or recycling.

For example, the problem of disposing the beverage container after its use could be overcome by using cellulose for the beverage container since cellulose is not only compostable but also has a material strength that is sufficient to provide the container with the rigidity required in the beverage preparation process. However, cellulose does not inherently possess an oxygen or moisture barrier. Typically, an oxygen and/or moisture barrier protects the component inside the container from degradation and is therefore important for the shelf life of the beverage container.

Generally, it is known how to provide a cellulose body with an oxygen barrier. For example, a film made from (bio) plastic can be attached to the cellulose body.

However, the same cannot be found for the provision of a moisture barrier on a cellulose body. For example, metals or certain plastic films, such as Polyvinylidene dichloride (PVDC), are known for their moisture barrier properties. However, the materials have to be applied as a thin layer for the beverage container to be able to remain compostable. Unfortunately, this makes the structure forming the moisture barrier susceptible to mechanical stresses and thus, it cannot undergo excessive stretching or deformation during or after attachment on the beverage container without risking the moisture barrier's structural integrity. In addition, the materials used for the moisture barrier do not sufficiently adhere to the cellulose body or the materials for the oxygen barrier because the respective materials are too dissimilar in their material characteristics and bonding mechanisms.

For these reasons, cellulose based beverage containers typically do not have a moisture barrier, and instead, are provided with an oxygen barrier only. However, there is a need for cellulose based beverage containers to have a moisture barrier to keep the flavours of the beverage component inside the beverage container and to improve shelf life.

Therefore, it is an object of the present invention to provide a compostable beverage container, such as a pod or capsule, with an oxygen barrier and a moisture barrier. Furthermore, it is an object of the present invention to provide a method that facilitates the production of a beverage container with an oxygen barrier and a moisture barrier. Therein, it is a particular object of the invention that the beverage container regardless of its design, shape and/or size can be provided with a moisture and an oxygen barrier.

These and other objects, which become apparent upon reading the description, are solved by the subject-matter of the independent claims. The dependent claims refer to preferred embodiments of the invention.

### 3. SUMMARY OF THE INVENTION

A first aspect of the invention relates to a beverage container for preparing a beverage by injecting a fluid into a cavity inside the beverage container. The cavity encloses a substance for the beverage preparation. The beverage container comprises a layered structure with a moisture (barrier function) and (an) oxygen barrier function. The layered structure comprises a cellulose body, which defines the cavity. The layered structure comprises coating layers. The coating layers are applied on the cellulose body as a layered construction. The coating layers comprise a surface coating being a base coating that forms the layer of the layered construction closest to the cellulose body. The coating layers comprise a moisture barrier coating to provide the moisture barrier function.

In other words, a receptacle can be provided that is suitable for preparing a beverage in a beverage preparation machine. The beverage container may have a compartment, (hollow) space or chamber that contains the substance. Thus, the beverage container may be a three-dimensional body enclosing a cavity. Injecting a fluid in the cavity during the beverage preparation process may lead to an interaction of the fluid with the substance, which may include any kind of chemical and/or physical reaction between the substance and the fluid, such as wetting, infusion, extraction, dissolution, and/or any other kind of corresponding interaction to produce a beverage product. The substance may be any type of (solid, liquid, at least partially soluble and/or percolate-able) matter of a particular or definite chemical constitution. The beverage container may have a construction (configuration) that may be formed by layers, plies, slats, tiers or strata. Preferably, the layers may be stacked in a direction normal to the respective surface covered by the layers. The layered structure of the beverage container comprises a moisture barrier function as well as an oxygen barrier function, i.e. it may comprise a configuration that may prevent or block not only gases, such as oxygen, but also fluids (i.e. liquid and/or gaseous substances) from entering and/or leaving the (cavity) inside of the beverage container. Naturally, the layered structure may also be configured to provide a barrier function against other gases than oxygen, e.g. flavouring substances. The layered structure comprises a (rigid) cellulose body that may outline or prescribe the (general) shape and/or geometry of the cavity. The layered structure comprises coating layers, which are applied on the cellulose body in a layered construction. Thus, the layered structure may comprise (different, thin, solid and/or adherent) layers of coating substance(s) adapted to change surface properties of the substrate, to which they are applied. The coating layers may be provided (arranged) in a layered manner. One of the coating layers is a moisture barrier coating for the moisture barrier function. Further, one of the coating layers is a surface coating that may function as a base coating and that is the layer of the layered construction that may be nearest to the cellulose body in a direction normal to the respective surface (e.g. of the cellulose body) covered by the layered construction.

As a surface coating forms part of the layered construction, coatings of otherwise non-adhering materials can be applied and combined on a surface of a beverage container. Further, by having the surface coating as the coating layer closest to the cellulose body, sufficient adhesion between the cellulose body and the moisture barrier can be ensured. Additionally, by providing the moisture barrier as a coating, beverage containers can be provided with a reliable moisture barrier irrespective of their design or shape as there is no need to consider mechanical stresses of the moisture barrier material due to the shape of the beverage container. Thus, the configuration of the present invention enables to provide a cellulose based beverage container not only with an oxygen barrier but also with a moisture barrier. Additionally, the beverage container can be provided with different functional layers due to its layered configuration. Further, the beverage container can be compostable as coatings can be provided with a low thickness that is sufficient to maintain compostability. Thus, with the present invention it is possible to overcome the above described problems of prior art beverage containers.

According to a preferred embodiment, the surface coating may be configured to provide a reduced—in comparison to another layer of the layered structure, on which the surface coating is applied—pore size, air permeability and/or surface roughness. Preferably, the cellulose body may be the other layer, on which the surface coating is applied. For example, the roughness can be comprised in the range of from 30 to 800 Bendsten ml/min (Bendsten method). For example, the surface coating may be an acrylic-based coating, which is preferably applied as a spray or plasma.

Thereby, the adhesion between the surface coating and the following coating layer can be improved as unevenness, voids or pores of the surface covered by the surface coating are evenly filled. This facilitates uniform interlocking between the respective surfaces.

According to a further preferred embodiment, the surface coating may be provided on the cellulose body as a surface layer, which is treated in a chemical process and/or in a mechanical process. For example, the surface layer of the cellulose body may be chemically treated by using acids. Alternatively or additionally, the surface layer of the cellulose body may be mechanically treated, for example in a calendering process.

Thereby, it is possible to adapt a region on and below the surface of the cellulose body to be covered by the coating layers. Thus, a strong bond between dissimilar materials can be established that rely on suitable surface textures for bonding. For example, in a calendering process, the cellulose body may be exposed to heat and pressure so that the surface texture changes. Similar modifications of the surface texture may be derived by chemically treating the surface of the cellulose body that is to be covered by the coating layers. The change in the surface texture may be observed directly on the surface and/or up to a certain depth below the surface that was treated in the respective process.

According to a preferred embodiment, the moisture barrier coating may be directly applied onto the surface coating.

Thus, by providing the moisture barrier coating in immediate physical contact (i.e. directly) with the surface coating, reliable adhesion of the moisture barrier coating on the beverage container can be ensured. In particular, the surface coating provides a surface for adherence that has defined surface properties. Thus, the reliability and durability of the moisture barrier function of the beverage container can be improved.

According to a further preferred embodiment, the moisture barrier coating may comprise Polyvinylidene dichloride (PVDC), nanocellulose, microcellulose, Silicon nitride and/or Aluminium. Preferably, the moisture barrier coating may be provided by spraying, lacquering, plasma coating, or by metallisation, e.g. in a physical vapour depositing process. For instance, the moisture barrier coating may be applied (in anyone of these processes) onto one of the coating layers of the layered construction.

Thereby, the moisture barrier can be provided as a coating while a reliable and adequate moisture barrier for the beverage container can be supplied. Further, the specified materials for the moisture barrier coating allow the coating having a low material thickness so that the compostability of the beverage container can be maintained.

According to a preferred embodiment, the layered structure may further comprise an oxygen barrier layer for providing the oxygen barrier function. The oxygen barrier layer may preferably be made from a preferably compostable plastic film. For example, the oxygen barrier layer may comprise Polyvinyl Alcohol (PVOH). The oxygen barrier layer (or the film) may preferably be laminated or heat-sealed onto the cellulose body or the layered construction of the coating layers.

Thus, the beverage container can be provided with an oxygen barrier in established processes while still allowing the beverage container to be compostable.

According to a further preferred embodiment, the oxygen barrier layer may be (arranged) opposite to the cellulose body with respect to the coating layers. Alternatively or additionally, the oxygen barrier layer may be sandwiched between the cellulose body and the coating layers. Alternatively or additionally, the oxygen barrier layer may be (arranged) opposite to the coating layers with respect to the cellulose body. Alternatively or additionally, the oxygen barrier layer may be (arranged) on the cavity or opposite to the cavity with respect to the cellulose body.

Thereby, the oxygen barrier can be protected from moisture in case materials with moisture sensitivity are used for the oxygen barrier. For example, this can be achieved by sandwiching the oxygen barrier between moisture resistant materials, such as the moisture barrier coating, or by providing the oxygen barrier on the cavity, which typically is exposed to moisture (only) during the beverage preparation process.

According to a preferred embodiment, the coating layers may further comprise an oxygen barrier coating for providing the oxygen barrier function. Preferably, the oxygen barrier coating may be applied (directly) on the surface coating. For example, the oxygen barrier function may be applied by spraying, lacquering, plasma coating, or by metallisation, e.g. in a physical vapour depositing process. Alternatively or additionally, the moisture barrier coating may be applied (directly) onto the oxygen barrier coating.

Thereby, the oxygen barrier can be also provided as a coating and can be applied together with the other coating layers. Thus, production of beverage container can be simplified. Moreover, the adhesion of the oxygen barrier material to the other coating layers can be improved. Therein, the oxygen barrier coating may even be able or configured to provide the functionality of the surface coating. Thus, the oxygen barrier coating may be able to act or support the integrity of the layered construction (e.g. in a similar or identical way as the surface coating).

According to a further preferred embodiment, the cellulose body may comprise the oxygen barrier function. Preferably, the oxygen barrier function may be provided by the cellulose body. For example, the cellulose body may provide the oxygen barrier function by the composition of its material or compactness of the cellulose body. Alternatively or additionally, the oxygen barrier function may be provided by the cellulose body being treated in a chemical process, e.g. using acids, and/or in a mechanical process, e.g. a calendering process.

Thereby, it is possible to provide the beverage container with an oxygen barrier that is integrated within the cellulose body. Thereby, the reliability of the oxygen barrier can be improved since the cellulose body encloses the cavity with the substance and thus, protects the substance from all sides. Also, the manufacturing process of the beverage container can be improved.

According to a preferred embodiment, the coating layers may comprise a masking coating for protecting the integrity of the moisture barrier coating. Preferably, the moisture barrier coating may be sandwiched between the masking coating and the surface coating. Alternatively or additionally, the masking coating may be applied directly on the moisture barrier coating.

Thereby, the moisture barrier coating can be protected from scratches or other environmental influences (temperature, exposure to gases or UV degradation) that may influence the integrity of the moisture barrier coating. This may be particularly relevant in case the moisture barrier coating is formed as a relatively thin coating layer, such as in metallization processes, and thus, more susceptible to being mechanically damaged.

According to a further preferred embodiment, the coating layers may comprise a top layer coating, which forms an inside or outside surface of the beverage container. Preferably, the top layer coating may delimit the cavity. Alternatively or additionally, the top layer coating may be a sealing layer for heat-sealing. For example, the top layer coating may be applied by spraying or lacquering (to the layered construction).

Thereby, it is possible to provide the beverage container with an additional coating that may protect the remaining coating layers from heat and/or that may be used to seal the beverage container onto other structures, such as a lid, by applying heat, for example.

According to a preferred embodiment, the outside of the beverage container may be formed by the cellulose body or the coating layers (preferably the masking coating). Preferably, the cavity may be delimited by the oxygen barrier layer or the masking coating.

Thereby, it is possible to avoid that the cellulose body absorbs the fluid injected into the cavity. By providing the coating layers on the outside of the beverage container it can be avoided that the beverage container gets stuck or dissolves inside the container receiver of the beverage preparation machine.

According to a further preferred embodiment, the beverage container may be compostable. Preferably, the beverage container may be a rigid, three-dimensional body.

By designing the beverage container with a certain amount of stiffness, pressure built-up in the cavity can be ensured while avoiding collapse thereof during opening. Therein, stiffness is a property of the structure (e.g. the cellulose body or the beverage container) and thus, dependent upon various physical parameters (e.g. elastic modulus) and the dimensions that describe that structure.

The beverage container may be a pod or a capsule. The cellulose body may have a wall section that delimits the cavity. Therein, the coating layers may be preferably provided on at least the wall section. More preferred, the coating layers may be provided on the same side as and/or on a different side to the cavity with respect to the wall section.

Thereby, it is possible to provide the moisture and oxygen barrier at least on parts of the beverage container that enclose the substance for the beverage preparation.

A further aspect of the present invention relates to a method for producing a beverage container having a layered structure with a moisture and oxygen barrier function. Therein, the beverage container is configured for preparing a beverage by injecting a fluid into a cavity for enclosing a substance for beverage preparation inside the beverage container. The method comprises the step of defining a cellulose body to form the cavity. Coating layers are applied on the cellulose body to form a layered construction. The coating layers comprise a surface coating, which is a base coating that forms the layer of the layered construction closest to the cellulose body. The coating layers further comprise a moisture barrier coating to provide the moisture barrier function.

Preferably, the step of applying coating layers may further comprise applying an oxygen barrier coating, e.g. by spraying or by metallisation. Alternatively or additionally, an oxygen barrier layer for providing the oxygen barrier function, e.g. by lamination, may be applied. Alternatively or additionally, a masking coating for protecting the integrity of the moisture barrier coating may be applied. Alternatively or additionally, a top layer coating for heat-sealing may be applied.

Thereby, it is possible to produce a compostable beverage container with a moisture and an oxygen barrier displaying also all of the advantages described in detail above for the beverage container.

According to a further preferred embodiment, the cavity may be filled with a food product as the substance. Preferably, the cavity may be sealed with a lid. The sealing may be done preferably before applying the coating layers to the cellulose body on the outside of the beverage container.

Thereby, it is possible to produce a beverage container from compostable materials in a cost effective and simplified manner that facilitates to form the beverage container and to apply the coatings at the site of filling without the need of providing special manufacturing machinery. Thus, problems existing in manufacturing methods of the prior art can be overcome by the present invention.

### 4. BRIEF DESCRIPTION OF DRAWINGS

Further features, advantages and objects of the invention will become apparent for the skilled person when reading the following detailed description of embodiments of the invention and when taking in conjunction with the figures of the enclosed drawings. In case numerals have been omitted from a figure, for example for reasons of clarity, the corresponding features may still be present in the figure.

FIGS. 1 to 5 show a section of a schematic cross-section of a beverage container according to different embodiments of the invention, respectively.

FIG. 6 shows a perspective view of a section of a beverage container according to an embodiment of the invention.

FIG. 7 shows a perspective view of a beverage container according to a further embodiment of the invention.

### 5. DETAILED DESCRIPTION

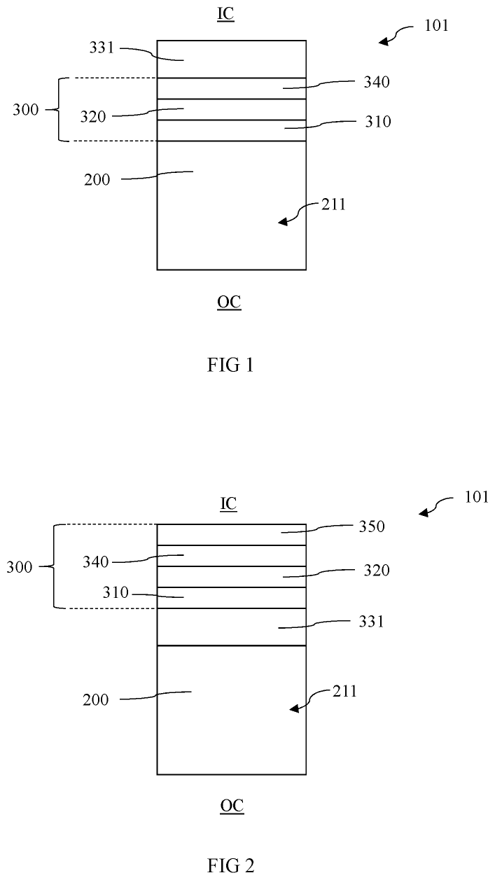

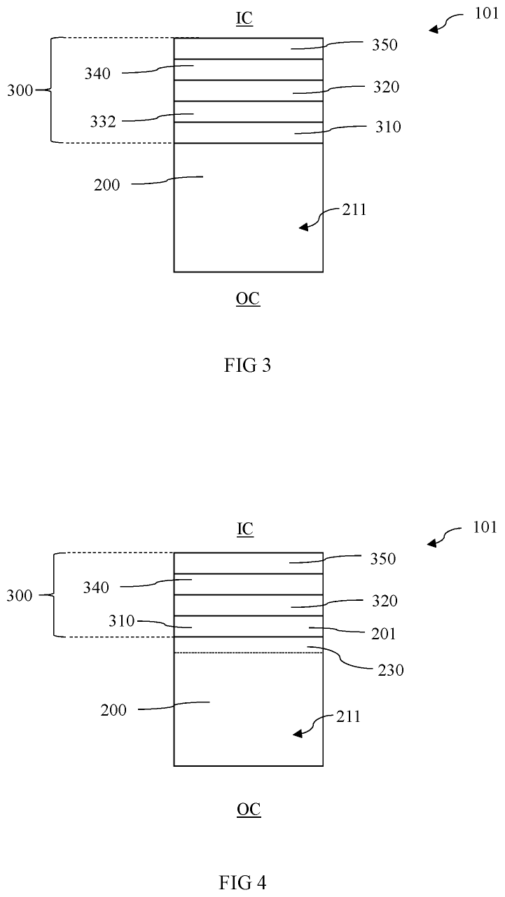

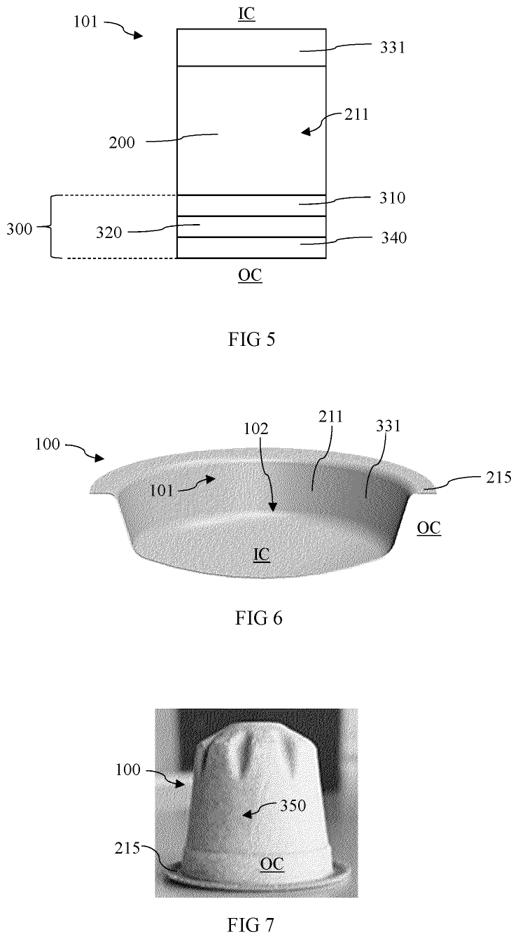

The Figures show different views and aspects of different embodiments of a beverage container 100 according to the present invention. In particular, FIGS. 1 to 5 show schematic illustrations of a cross-section of the beverage capsule 100 according to different embodiments of the invention. FIGS. 6 and 7 show perspective views of the beverage container 100 according to further embodiments of the invention.

The beverage container 100 is suitable (configured) for preparing a beverage by injecting a fluid inside the beverage container 100. For example, the beverage container 100 may be suitable for use with a beverage preparation machine, such as a capsule machine. The beverage container 100 may be placeable inside a capsule holder of the capsule machine. For instance, in FIGS. 6 and 7, the beverage container 100 is exemplarily shown as a pod and a capsule, respectively, both being suitable for being received by a corresponding capsule holder of a capsule machine. For example, the beverage container 100 may have a round or circular shape. Preferably, the beverage container 100 may extend between two ends, wherein an opening into the beverage container 100 may be provided on one end. However, the beverage container 100 may have any other shape that may be suitable for preparing a beverage in a beverage preparation machine.

The beverage container 100 may have a three-dimensional body. This is exemplarily illustrated in FIGS. 6 and 7. Preferably, the beverage container 100 may be made of material(s) and/or contain substances that are (all) compostable. Therein, international standards, such as EU 13432 or US ASTM D6400, specify technical requirements and procedures for determining biodegradability and compostability of a material. For example, one of the tests requires that—for a material to be considered “industrially compostable”—at least 90% of the material in question must be biologically degraded under controlled conditions in 6 months. Similar test schemes exist also for a certification to home compostability.

The beverage container 100 may have rigid or soft structure (i.e. may have a material and design configuration leading thereto, for example). Preferably, the beverage container 100 may have a defined stiffness or flexibility. Further, the beverage container 100 is suitable (configured) for preparing a beverage by injecting a fluid, such as hot (40° C. to 100° C.) water or milk, inside the beverage container 100, preferably with the application of pressure (1 to 20 bar).

The beverage container 100 comprises a layered structure 101. The layered structure 101 is exemplarily shown in all Figures, but FIGS. 1 to 5 are particularly suitable. The layered structure 101 comprises a moisture barrier function and an oxygen barrier function. For example, the layered structure 101 may provide the oxygen and moisture barrier function through its individual layers. The respective layers may be configured such that they can provide the respective barrier function for blocking the respective medium (e.g. water and/or a gas, such as oxygen) from entering and/or leaving the beverage container 100 while ensuring good cohesion between the individual layers.

The oxygen barrier function may provide the beverage container 100 with a reduced oxygen transmission rate (OTR) on 3D shape corresponding to an OTR in flat shaped material below 1 cm³/(m²·bar·day). Therein, the OTR may be a measure of the amount of oxygen gas that passes through a substance over a defined period. For example, the OTR may be measured using known methods specified in industrial standards, such as DIN 53380-3, ASTM D1434 or ISO 2872.

The moisture barrier function may provide the beverage container 100 with a reduced moisture transmission rate (MTR) on 3D shape corresponding to a MTR in flat shaped material below 1 g/m²/day. Therein, the MTR may be a measure of the passage of moisture (e.g. water vapour) through the walls of the beverage container 100. For example, the MTR may be measured using known methods specified in industrial standards, such as ASTM E96.

Further details on the moisture and oxygen barrier functions, specifically on how they are effected, are explained in more detail in the following.

The layered structure 101 comprises a cellulose body 200. The cellulose body 200 defines a cavity 102 inside the beverage container 100. For example, the cellulose body 200 may have a wall section 211 and (an integrally provided) bottom wall that delimit the cavity 102. Thus, the shape and contours of the cavity 102 may be determined by the wall section 211. Similarly, the shape and contours of the beverage container 100 may be determined by the wall section 211. This is exemplary shown in FIG. 6. The cellulose body 200 may comprise biodegradable pulp material, such as pulp fibre cellulose, bagasse pulp, bamboo pulp, and/or wood pulp. Depending on the pulp fibre used, the stiffness of the cellulose body 200 may vary. Preferably, the cellulose body 200 may be made by pulp moulding. Therein, the pulp may be pressed (with or without the application of heat) into a mould to form at least part of the cellulose body 200. Also, paper forming is possible.

The cavity 102 encloses a substance for beverage preparation. Thus, a position relative to the cavity 102 may be on a container inside IC (e.g. in the cavity 102) or on a container outside OC. The respective positions are exemplarily marked in all Figures. For example, when injecting a fluid (such as hot (40° C. to 100° C.) water or milk) inside the beverage container 100 for the beverage preparation, the substance may interact with the fluid injected in the cavity 102 to produce the desired beverage. Thus, the cavity 102 (or more generally the beverage container 100) may constitute a brewing chamber of the beverage preparation machine or in the beverage preparation process. Examples for substances may be roasted ground coffee, instant coffee, tealeaves, syrup concentrate, fruit extract concentrate, chocolate, dehydrated edible substances, and/or combinations thereof.

The layered structure 101 further comprises coating layers 300, which are applied on the cellulose body 200 as a layered construction. For example, the coating layers 300 may be provided on at least the wall section 211. Therein, the coating layers 300 may be provided on either the same side or on a different side to the cavity 102 with respect to the wall section 211. For example, in FIGS. 1 to 4, the coating layers 300 are exemplarily illustrated as preferably being at least close to or on the container inside IC, thus on the same side as the cavity 102 with respect to the wall section 211. In comparison, in FIG. 5, the coating layers 300 are exemplarily shown on the container outside OC, thus on a different side as the cavity 102 with respect to the wall section 211. Thus, the outside of the beverage container 100 may be formed by the cellulose body 200 or the coating layers 300, for example. However, it is also conceivable that the coating layers 300 may be provided on both sides with respect to the wall section 211.

For example, the coating layers 300 may be different to layers formed by applying a film to a body made of cellulose. This may be noticeable in the thickness of the material of the coating forming the respective layer. For example, the coating layers 300 may have (separately and) individually a thickness of 20 to 250 μm. Also, the material bonding and cohesion between the respective materials may be different to the material bonding between film layers. Also, surface unevenness may be levelled by a coating to a higher extent than with a film. For example, the surface roughness of the coating layers 300 may be 10 to 100 μm. The coatings forming the coating layers 300 may be applied onto the respective substrate to be coated as liquids, vapours or plasma, respectively.

FIGS. 1 to 5 exemplarily illustrate the layered construction of the coating layers 300. Therein, the individual coating layers 300 may be arranged in a stacked manner. The stacking direction may be a direction normal to the respective surface covered by the coating layers 300. For example, the different sections of the surface of the cavity 102 may be continuously (and/or cohesively) covered by the coating layers 300. Accordingly, the surface normal may vary depending on the respective section of the surface to be covered with the coating layers 300. However, the stacking order of the coating layers 300 may be unaffected in this direction irrespective of any local variation of the surface normal for different sections.

The coating layers 300 comprise a surface coating 310. The surface coating 310 is a base coating that forms the layer of the layered construction closest to the cellulose body 200. This is exemplarily illustrated in FIGS. 1 to 5. In FIGS. 1 and 3 to 5, the surface coating 310 is exemplarily illustrated as being directly applied onto the cellulose body 200. However, it is also conceivable to apply the surface coating 310 on different materials or layers of the layered structure 101, such as exemplarily illustrated in FIG. 2.

The surface coating 310 may be configured such that pore size, air permeability and/or surface roughness is reduced in comparison to another layer of the layered structure 101, on which the surface coating 310 is applied. For example, the surface coating 310 may have a smaller pore size or lower surface roughness than the cellulose body 200. Preferably, the surface coating 310 may provide a surface as a base, on which various other coatings can be adhered with known coating processes.

The surface coating 310 may be an acrylic-based coating. The surface coating may be applied as a spray or plasma. Alternatively or additionally, the surface coating 310 may be a surface layer 201 of the cellulose body 200 after it having received chemical or mechanical treatment. This is exemplarily shown in FIG. 4. For example, the surface layer 201, onto which the coating layers 300 are to be applied, may be treated in a chemical and/or in a mechanical process. For example, to alter the cellulose body's 200 surface properties, (a section of) the respective surface of the cellulose body 200 may be exposed to acids or subjected to heat and pressure in a calendering process. It is also conceivable that the surface coating 310 may be applied additionally besides the chemical or mechanical treatment leading to the surface layer 201. This is exemplarily illustrated in FIG. 4.

Furthermore, the coating layers 300 comprise a moisture barrier coating 320 to provide the moisture barrier function. This is exemplarily illustrated in FIGS. 1 to 5.

Preferably, the moisture barrier coating 320 may be directly applied onto the surface coating 310 or the surface layer 201. This is exemplarily illustrated in FIGS. 1, 2, 4 and 5. However, it is also conceivable that moisture barrier coating 320 may be applied to one of the other coating layers 300, such as exemplarily illustrated in FIG. 3. For example, the moisture barrier coating 320 may comprise Polyvinylidene dichloride (PVDC), nanocellulose, microcellulose, Silicon nitride and/or Aluminium. Preferably, the moisture barrier coating 320 may be applied to the respective surface to be coated by spraying, lacquering, plasma coating, or by metallisation. For instance, a physical vapour depositing process may be used for applying the moisture barrier coating 320.

Various options may exist for providing the oxygen barrier function, some of which being discussed in more detail below:

For example, the layered structure 101 may comprise an oxygen barrier layer 331 for providing the oxygen barrier function. This is exemplarily shown in FIGS. 1, 2, 5 and 6. Therein, the oxygen barrier layer 331 may be made from a compostable plastic film, such as Polyvinyl Alcohol (PVOH), or BVOH for instance (Butenediol Vinyl Alcohol Co-polymer). The plastic film may be, moulded, laminated or heat-sealed onto the cellulose body 200. This is exemplarily shown in FIGS. 2, 5 and 6. Alternatively or additionally, the plastic film may be laminated or heat-sealed onto the layered construction of the coating layers 300. This is exemplarily shown in FIG. 1. However, these are only examples and do not represent a complete enumeration. As can be taken from FIGS. 1, 2 and 5, various options may exist to arrange the oxygen barrier layer 331 relatively to the cellulose body 200 and the coating layers 300. For example, the oxygen barrier layer 331 may be arranged opposite to the cellulose body 200 with respect to the coating layers 300 (FIG. 1). Alternatively or additionally, the oxygen barrier layer 331 may be arranged sandwiched between the cellulose body 200 and the coating layers 300 (FIG. 2). It is also conceivable that the oxygen barrier layer 331 may be arranged opposite to the coating layers 300 with respect to the cellulose body 200 (FIG. 5). Thus, the oxygen barrier layer 331 may form an inside or outside surface of the beverage container 100. Hence, the cavity 102 may be delimited by the oxygen barrier layer 331 in a configuration such as exemplarily illustrated in FIGS. 1, 5 and 6.

Alternatively or additionally, the coating layers 300 may comprise a coating layer for providing the oxygen barrier function. This is exemplarily shown in FIG. 3. For example, the coating layers 300 may comprise an oxygen barrier coating 332 for providing the oxygen barrier function. Therein, the oxygen barrier coating 332 may be applied directly on the surface coating 310. Alternatively or additionally, the moisture barrier coating 320 may be directly applied onto the oxygen barrier coating 332. This is exemplarily shown in FIG. 3, where the oxygen barrier coating 332 is sandwiched between the moisture barrier coating 320 (on the side facing the container inside IC) and the surface coating 310 (on the opposite side thereto, e.g. the side facing the container outside OC). This may be accomplished, for instance, by spraying, lacquering, plasma coating, or by metallisation. For metallisation, a physical vapour depositing process may be used. However, also other arrangements of the oxygen barrier coating 332 within the layered construction are conceivable.

It is also conceivable that the cellulose body 200 may comprises the oxygen barrier function. This is exemplarily illustrated in FIG. 4. Therein, the oxygen barrier function may be provided by the cellulose body 200 itself. For example, the cellulose body 200 may have a constitution or composition that allows to provide the above specified oxygen barrier functionality. For instance, the cellulose body 200 may comprise a high portion of fibres and/or may have a high compactness. Alternatively or additionally, an upper surface layer 230 of the cellulose body 200 may be mechanically or chemically treated to establish the oxygen barrier function. This is exemplarily shown in FIG. 4. For this, a surface of the cellulose body 200 may be treated with acids, and/or may be exposed to pressure and heat in a calendering process. Therein, it is also conceivable that the upper surface layer 230 may be the same as the surface layer 201 of the cellulose body 200 and thus, may also provide the functionalities that otherwise may be provided by the surface coating 310. However, this is not a complete enumeration and other configurations and processes are conceivable.

Preferably, the layer of the layered structure 101 providing the oxygen barrier function may be arranged on the container inside IC (e.g. FIGS. 1 and 5) or may be arranged between the cellulose body 200 and the coating layers 300 (e.g. FIGS. 2 and 3). For example, this may allow to improve retaining the oxygen barrier function during the entire shelf-life of the beverage container 100 as the respective layer of the layered structure 101 can be sheltered from direct contact with moisture from the outside environment.

The coating layers 300 may further comprise a masking coating 340 for protecting the integrity of the moisture barrier coating 320. While this is exemplarily illustrated in all of FIGS. 1 to 5, the masking coating 340 may be optional (preferably in general and/or in all of FIGS. 1 to 5). The masking coating 340 may be made of an organic based material or metal and may be included in the layered construction by spraying, lacquering, plasma coating, or by metallisation. Preferably, the masking coating 340 may be arranged such that it sandwiches the moisture barrier coating 320 (only/exclusively) together with the surface coating 310. This is exemplarily illustrated in FIGS. 1 to 5. Therein, the masking coating 340 may be directly applied on the moisture barrier coating 320. It is also conceivable that the masking coating 340 may form an inside or outside facing surface of the beverage container 100. For instance, the cavity 102 may be delimited by the masking coating 340. Alternatively or additionally, the outside of the beverage container 100 may be formed by the masking coating 340, as shown in FIG. 5.

Moreover, the coating layers 300 may comprise a top layer coating 350 forming an inside or outside surface of the beverage container 100. The top layer coating 350 may be a sealing layer for heat-sealing. The top layer coating 350 may be configured or made of a material that allows to protect the coating layers 300 from heat and/or to act as a sealant in heat sealing applications. The top layer coating 350 may be made of a of an organic based material or metal and may be included in the layered construction by spraying, lacquering, plasma coating, or by metallisation. For example, the top layer coating 350 may delimit the cavity 102, as shown in FIGS. 2 to 4. Alternatively or additionally, the top layer coating 350 may form the outside surface of the beverage container 100, as shown in FIG. 7. Although not explicitly illustrated, it is also conceivable that each of the examples in FIGS. 1 and 5 may be provided with the top layer coating 350.

A further aspect of the invention relates to a method for producing the above described beverage container 100. Therein, the cellulose body 200 is defined so as to form the cavity 102. Thus, the cellulose body 200 may be provided with a three-dimensional body that may enclose the cavity 102. For example, a pulp moulding process may be completed to provide the cellulose body 200. Preferably, the cellulose body 200 may have its finished shape before proceeding to further (subsequent) steps. The above described coating layers 300 are provided on the cellulose body 200 as to form the layered construction. It is conceivable that the cavity 102 may be filled with a food product as the substance first and then sealed with a lid. The lid may be sealed to a rim portion 215 of the cellulose body 200 as, for example, exemplarily illustrated in FIGS. 6 and 7. Subsequently, the coating layers 300 may be applied to the cellulose body 200 on the outside of the beverage container 100.

For example, the beverage container 100 of FIG. 1 may be formed (or laminated) by applying the surface coating 310 to the (finished) cellulose body 200 (or to its wall section 211). The moisture barrier coating 320 may be applied. Other layers of the coating layers 300 may be added, such as the masking coating 340 or the top layer coating 350. Subsequently, the oxygen barrier layer 331 may be formed onto the coating layers 330 that cover (follow) the (solid) contours of the cellulose body 200 or the cavity 102.

In FIG. 2, for instance, the beverage container 100 may be formed by moulding the cellulose body 200 together with the oxygen barrier layer 331 into shape. The surface coating 310 and the moisture barrier coating 320 may be applied. Subsequently, other layers of the coating layers 300 may be added, such as the masking coating 340 or the top layer coating 350.

In FIG. 3, for example, the beverage container 100 may be formed by applying the surface coating 310 to the (finished) cellulose body 200 (or to its wall section 211). The oxygen barrier function may be provided to the beverage container 100 by applying the oxygen barrier coating 332 onto the surface coating 310. Subsequently, the moisture barrier coating 320 may be applied. Also, other layers of the coating layers 300 may be added, such as the masking coating 340 or the top layer coating 350.

In FIG. 4, for instance, the beverage container 100 may be formed by subjecting a surface of the (finished) cellulose body 200 (or its wall section 211) to a mechanical or chemical treatment to provide the oxygen barrier function. Therein, the treated surface of the cellulose body 200 may provide not only the oxygen barrier function but also act as the surface coating 310 through the upper surface layer 230 and the surface layer 201. It is conceivable that the upper surface layer 230 and the surface layer 201 are the same layer of the cellulose body 200. Then, the moisture barrier coating 320 may be applied thereon. Subsequently, other layers of the coating layers 300 may be added, such as the masking coating 340 or the top layer coating 350.

In FIG. 5, for example, the beverage container 100 may be formed by moulding the cellulose body 200 (or its wall section 211) together with the oxygen barrier layer 331 into shape. Then, on an opposite side to the oxygen barrier layer 331 with respect to the cellulose body 200, the surface coating 310 and the moisture barrier coating 320 may be applied. Subsequently, other layers of the coating layers 300 may be added, such as the masking coating 340 or the top layer coating 350.

However, these are only examples and not a complete enumeration of possible configurations of the method for producing the beverage container 100.

The invention is not limited by the embodiments as described hereinabove, as long as being covered by the appended claims. All the features of the embodiments described hereinabove can be combined in any possible way and be provided interchangeably.

For example, the layered structure 101 may comprise further layers, such as an additional oxygen barrier layers 331. It is further conceivable that the beverage container 100 may comprise more than one of the above described coating layers 300. Alternatively or additionally, it is conceivable that the coating layers 300 may comprise one or more of the above described coatings, such as the surface coating 310, the moisture barrier coating 320, the oxygen barrier coating 332, the masking coating 340 and/or the top layer coating 350.

1. A beverage container for preparing a beverage by injecting a fluid into a cavity inside the beverage container that encloses a substance for beverage preparation, the beverage container having a layered structure with a moisture and oxygen barrier function, wherein the layered structure comprises
a cellulose body defining the cavity, and
coating layers which are applied on the cellulose body as a layered construction,
wherein the coating layers comprise
a surface coating being a base coating forming the layer of the layered construction closest to the cellulose body, and
a moisture barrier coating to provide the moisture barrier function.

2. The beverage container according to claim 1, wherein the surface coating is configured to provide surface roughness in comparison to another layer of the layered structure, on which the surface coating is applied, preferably the cellulose body, wherein preferably the surface coating is an acrylic-based coating, which is preferably applied as a spray or plasma.

3. The beverage container according to claim 1, wherein the surface coating is provided on the cellulose body as a surface layer, which is treated in a chemical process.

4. The beverage container according to claim 1, wherein the moisture barrier coating is directly applied onto the surface coating or one of the coating layers, and
wherein the moisture barrier coating is selected from the group consisting of Polyvinylidene dichloride (PVDC), nanocellulose, microcellulose, Silicon nitride and Aluminium.

5. The beverage container according to claim 1, wherein the layered structure further comprises an oxygen barrier layer for providing the oxygen barrier function.

6. The beverage container according to claim 5, wherein the oxygen barrier layer is in a position selected from the group consisting of
opposite to the cellulose body with respect to the coating layers,
sandwiched between the cellulose body and the coating layers,
opposite to the coating layers with respect to the cellulose body, and
on the cavity or opposite to the cavity with respect to the cellulose body.

7. The beverage container according to claim 1, wherein the coating layers further comprise an oxygen barrier coating for providing the oxygen barrier function.

8. The beverage container according to claim 1, wherein the cellulose body comprises the oxygen barrier function.

9. The beverage container according to claim 1, wherein the coating layers comprise a masking coating for protecting the integrity of the moisture barrier coating.

10. The beverage container according to claim 1, wherein the coating layers comprise a top layer coating forming an inside or outside surface of the beverage container.

11. The beverage container according to claim 1, wherein the outside of the beverage container is formed by the cellulose body.

12. The beverage container according to claim 1, wherein the beverage container is a compostable, three-dimensional body, the cellulose body has a wall section defining the cavity.

13. A method for producing a beverage container having a layered structure with a moisture and oxygen barrier function, the beverage container being configured for preparing a beverage by injecting a fluid into a cavity for enclosing a substance for beverage preparation inside the beverage container, comprising:
defining a cellulose body so as to form the cavity;
applying coating layers on the cellulose body as to form a layered construction, wherein the coating layers comprise
a surface coating being a base coating forming the layer of the layered construction closest to the cellulose body, and
a moisture barrier coating to provide the moisture barrier function.

14. The method according to claim 13, wherein the step of applying coating layers further comprises applying
an oxygen barrier coating for providing the oxygen barrier function,
a masking coating for protecting the integrity of the moisture barrier coating, and
a top layer coating for heat-sealing.

15. The method according to claim 13, wherein the cavity is filled with a food product as the substance and is sealed with a lid.
